(19) United States
(12) Patent Application Publication
(10) Pub. No.: US 2008/0303241 A1
(43) Pub. Date: Dec. 11, 2008

(54) Hidden seat tube assembly for a bicycle

(76) Inventor: Hsing-Liu Liu, Taichung (TW)

Correspondence Address: Hsing-Liu Liu, 235 Chung-Ho, Box 8-24, Taipei, TW

(21) Appl. No.: 11/810,130

(22) Filed: Jun. 5, 2007

(51) Int. Cl. B62K 19/36

(52) U.S. Cl. 280/281.1

(57) ABSTRACT

A hidden seat tube assembly for a bicycle, comprises: a seat tube; a C ring installed within the seat tube therein; the C ring having an opening so that the C ring has a C cross section; the C ring being welded to an inner wall of the seat tube through at least one welding spot; a retainer arranged at two sides of the opening of the C ring; one side of the retainer having a through hole and another side of the retainer having a threaded hole; a screw unit retained within the through hole and threaded hole of the retainer; by adjusting the engagement position of the screw unit to threaded hole of the retainer, the cross section of the C ring being enlarged or reduced.

### FIELD OF THE INVENTION

The present invention relates to bicycle parts, and particularly to a hidden seat tube assembly for a bicycle, wherein a C ring is welded to the seat tube of a bicycle and a retainer is welded to the seat tube so that the whole structure is firm and concrete and thus has a long lifetime. Thereby the structure is hidden within the seat tube and thus the outlook is beautiful.

### BACKGROUND OF THE INVENTION

In a bicycle, a stand tube is installed within a seat tube. The stand tube serves to support a cushion. It is necessary to adjust the elevation of the cushion so as to suit for the pose of the driver.

Thus, in the prior art, an adjust structure is installed to the seat tube for adjusting the elevation of the stand tube. A ring is installed at an outer side of the seat tube and a screw is used to lock or release the seat tube for adjusting the elevation of the stand tube. However, the ring and screw are installed at the outer side of the seat tube and thus they are easily destroyed. Moreover, the outlook is not preferred.

Therefore, there is an eager demand for a novel design which can improve such defects so as to have a firm and concrete structure and has a long lifetime.

### SUMMARY OF THE INVENTION

Accordingly, the primary object of the present invention is to provide a hidden seat tube assembly for a bicycle, wherein a C ring is welded to the seat tube of a bicycle and a retainer is welded to the seat tube so that the whole structure is firm and concrete and thus has a long lifetime. Thereby the structure is hidden within the seat tube and thus the outlook is beautiful.

To achieve above objects, the present invention provides a hidden seat tube assembly for a bicycle, comprising: a seat tube; a C ring installed within the seat tube therein; the C ring having an opening so that the C ring has a C cross section; the C ring being welded to an inner wall of the seat tube through at least one welding spot; a retainer arranged at two sides of the opening of the C ring; one side of the retainer having a through hole and another side of the retainer having a threaded hole; This makes the structure of the present invention being more firmly and stable; a screw unit retained within the through hole and threaded hole of the retainer; by adjusting the engagement position of the screw unit to threaded hole of the retainer, the cross section of the C ring being enlarged or reduced.

The retainer is welded to the C ring. The C ring is welded to the seat tube. A part of the retainer having the through hole is opened at a transversal tube engaged to the seat tube. A part of the retainer having the threaded hole is hidden within a transversal tube engaged to the seat tube.

The various objects and advantages of the present invention will be more readily understood from the following detailed description when read in conjunction with the appended drawing.

### BRIEF DESCRIPTION OF THE DRAWINGS

FIG. 1 is a perspective view of the hidden seat tube assembly for a bicycle of the present invention.

FIG. 2A is a schematic cross sectional view of the hidden seat tube assembly for a bicycle of the present invention, where no screw unit is applied.

FIG. 2B is a schematic cross sectional view of the hidden seat tube assembly for a bicycle of the present invention, where a screw unit is applied.

FIG. 3 is a schematic view showing the application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

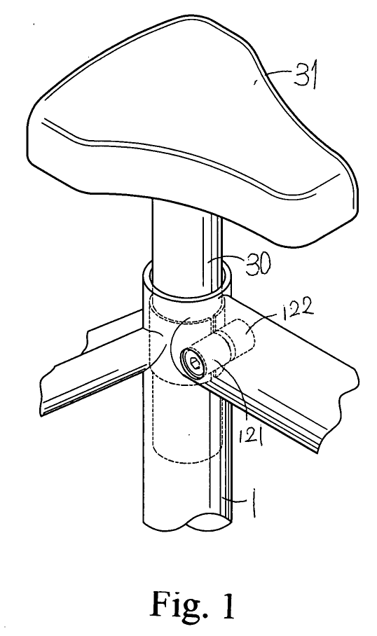

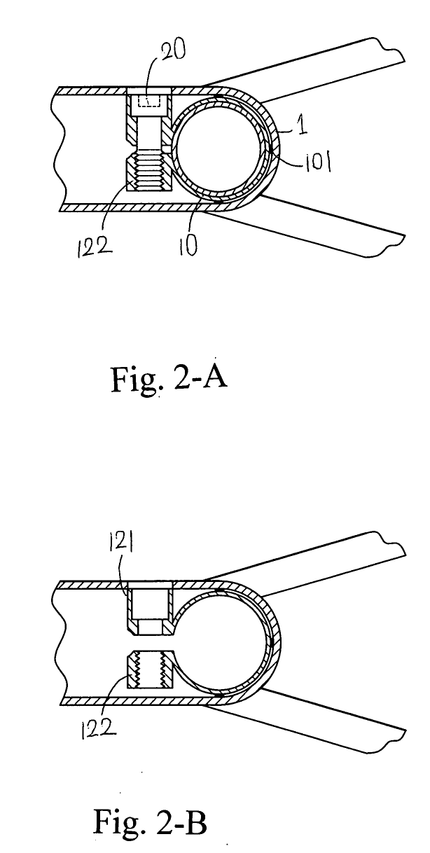

Referring to FIGS. 1, 2A and 2B, the structure of the present invention is illustrated. The present invention has the following elements.

A seat tube 1 is included. A C ring is installed within the seat tube 1 therein. The C ring 10 has an opening 11 so that the C ring 10 has a C cross section. The C ring 10 is welded to an inner wall of the seat tube 1 through at least one welding spot 101 (referring to FIGS. 2A and 2B).

A retainer 12 is arranged at two sides of the opening 11 of the C ring 10. One side of the retainer 12 has a through hole 121 and another side of the retainer 12 has a threaded hole 122. The retainer 12 is welded to the C ring 10. The part of the retainer 12 having the through hole 121 is opened at a transversal tube engaged to the seat tube 1. This makes the structure of the present invention being more firmly and stable.

A screw unit 20 is retained within the through hole 121 and threaded hole 122 of the retainer 12. By adjusting the engagement position of the screw unit 20 to the threaded hole 122 of the retainer 12, the cross section of the C ring 10 is enlarged or reduced.

In the present invention, the C ring 10 is welded to the seat tube 1 and the retainer 12 is welded to the seat tube 1 so that the whole structure is firm and concrete. Thereby the structure is hidden within the seat tube 1 and thus the outlook is beautiful.

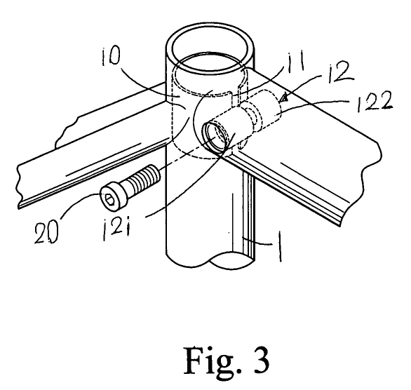

Referring to FIG. 3, the application of the present invention is illustrated. In use, a screw unit 20 below a cushion 31 passes through the C ring 10. The screw unit 20 passes through the through hole 121 and threaded hole 122 of the retainer 12. To adjust the elevation of the cushion 31, the screw unit 20 can be released from the retainer 12 and thus the stand tube 30 is displaced to cause that the cushion 31 has a desired position. Thus the screw unit 20 is tightened for fixing the cushion 31.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A hidden seat tube assembly for a bicycle, comprising:
a seat tube; a C ring installed within the seat tube therein; the C ring having an opening so that the C ring has a C shape cross section; the C ring being welded to an inner wall of the seat tube through at least one welding spot;
a retainer arranged at two sides of the opening of the C ring; one side of the retainer having a through hole and another side of the retainer having a threaded hole;
a screw unit retained within the through hole and threaded hole of the retainer; by adjusting the engagement position of the screw unit to the threaded hole of the retainer, the cross section of the C ring being enlarged or reduced.

2. The hidden seat tube assembly for a bicycle as claimed in claim 1, wherein the retainer is welded to the C ring.

3. The hidden seat tube assembly for a bicycle as claimed in claim 1, wherein the C ring is welded to the seat tube.

4. The hidden seat tube assembly for a bicycle as claimed in claim 1, wherein a part of the retainer having the through hole is opened at a transversal tube engaged to the seat tube.

5. The hidden seat tube assembly for a bicycle as claimed in claim 1, wherein a part of the retainer having the threaded hole is hidden within a transversal tube engaged to the seat tube.
